(19) United States
(12) Patent Application Publication
(10) Pub. No.: US 2015/0330937 A1
(43) Pub. Date: Nov. 19, 2015

(54) HAND-HELD TEST METER WITH BODY PORTION PROXIMITY SENSOR MODULE

(71) Applicant: LIFESCAN SCOTLAND LIMITED, Inverness (GB)

(72) Inventors: Brian GUTHRIE, Inverness (GB); David ELDER, Inverness (GB); John YOUNG, Inverness (GB); Ciaran CARNEY, Inverness (GB); Timothy LLOYD, Avoch (GB)

(73) Assignee: LIFESCAN SCOTLAND LIMITED, Inverness (GB)

(21) Appl. No.: 14/279,479

(22) Filed: May 16, 2014

(51) Int. Cl. G01N 27/327

(52) U.S. Cl. CPC G01N 27/3273

(57) ABSTRACT

A hand-held test meter for use with an analytical test strip (for example, an electrochemical-based analytical test strip) in the determination of an analyte (such as glucose) in a bodily fluid sample (e.g., a whole blood sample) includes a housing, a micro-controller disposed in the housing, a body portion proximity sensor module disposed at least partially in the housing, and a strip port connector configured to operationally receive an analytical test strip. The body portion proximity sensor module of the analytical test strip is configured to sense presence of a user's body portion (e.g., a user's finger, forearm or palm) within a predetermined distance of the strip port connector and, upon sensing the presence of such a body portion, transmit a signal to the micro-controller indicating the presence of such a body portion.

### BACKGROUND OF THE INVENTION

1. Field of the Invention

The present invention relates, in general, to medical devices and, in particular, to hand-held test meters and related methods.

2. Description of Related Art

The determination (e.g., detection and/or concentration measurement) of an analyte in, or characteristic of, a bodily fluid sample is of particular interest in the medical field. For example, it can be desirable to determine glucose, ketone bodies, cholesterol, lipoproteins, triglycerides, acetaminophen, haematocrit and/or HbA1c concentrations in a sample of a bodily fluid such as urine, blood, plasma or interstitial fluid. Such determinations can be achieved using a hand-held test meter in combination with analytical test strips (e.g., electrochemical-based analytical test strips).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified depiction of a hand-held test meter according to an embodiment of the present invention;

FIG. 2 is a simplified block diagram of various blocks of the hand-held test meter of FIG. 1;

FIG. 3 is a simplified combination schematic and block diagram of a body portion proximity sensor module, micro-controller and battery as can be employed in embodiments of hand-held test meters of the present invention;

FIG. 4 is a simplified schematic of another body portion proximity sensor module as can be employed in alternative embodiments of hand-held test meters according to the present invention operably connected to electrodes (E1 and E2) of an analytical test strip; and

FIG. 5 is a flow diagram depicting stages in a method for employing a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

In general, hand-held test meters for use an analytical test strip (such as, for example, an electrochemical-based analytical test strip) in the determination of an analyte (e.g., glucose) in, and/or a characteristic (such as hematocrit) of, a bodily fluid sample (for example, a whole blood sample) according to embodiments of the present invention include a housing, a micro-controller disposed in the housing, a body portion proximity sensor module disposed at least partially in the housing, and a strip port connector configured to operationally receive an analytical test strip. The body portion proximity sensor module of the analytical test strip is configured to sense presence of a user's body portion (such as a user's finger, user's forearm, user's palm or other body portion suitable for expressing a bodily fluid sample) within a predetermined distance of the strip port connector and, upon sensing the presence of such a user's bodily portion, transmit a signal to the micro-controller indicating the presence of such a user's bodily portion.

The body portion proximity sensor module can be based on, for example, capacitance sensing. Once apprised of the present disclosure, one skilled in the art will recognize that body portion finger proximity sensor modules employed in embodiments of the present invention and/or associated algorithms employed by the micro-controller can, if desired, be tuned to reliably sense characteristics of a particular body portion at a predetermined distance via routine experimentation.

Hand-held test meters according to embodiments of the present invention are beneficial in that the sensing of a user's body portion (such as a user's finger) within a predetermined distance (e.g., a distance of less than or equal to 10 mm or less than or equal to 5 mm) of the strip port connector in combination with the presence of an analytical test strip inserted into the strip port connector is an indication that a bodily fluid sample (typically a whole blood sample expressed from the user's fingertip or other suitable body portion) is about to be applied to the analytical test strip. This indication can be employed by the micro-controller to switch the hand-held test meter from a low-power stand-by state to a high-power activated state, thus beneficially saving battery power prior to the sensing of the user's finger. For example, once an analytical test strip is inserted into the test meter, the test meter can enter a low-power stand-by state wherein essentially only the body portion proximity sensor module, the micro-controller module and a display module of the test meter are powered. Subsequently, once a body portion is sensed at a predetermined distance, the high-power activated state can entered wherein the remainder of the test meter's electrical circuits (such as analog and digital electrical circuitry blocks employed in the determination of an analyte in an applied bodily fluid sample) are fully powered and, if desired, the body portion proximity sensor module de-powered (i.e., deactivated).

Once one skilled in the art is apprised of the present disclosure, he or she will recognize that an example of a hand-held test meter that can be readily modified as a hand-hand test meter according to the present invention is the commercially available OneTouch® Ultra® 2 glucose meter from LifeScan Inc. (Milpitas, Calif.). Additional examples of hand-held test meters that can also be modified are found in U.S. Patent Application Publications No's. 2007/0084734 (published on Apr. 19, 2007) and 2007/0087397 (published on Apr. 19, 2007) and in International Publication Number WO2010/049669 (published on May 6, 2010), each of which is hereby incorporated herein in full by reference.

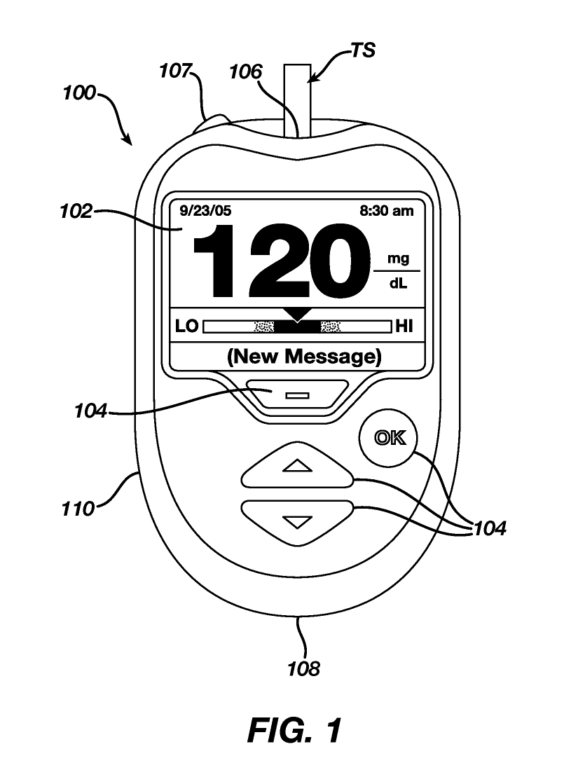

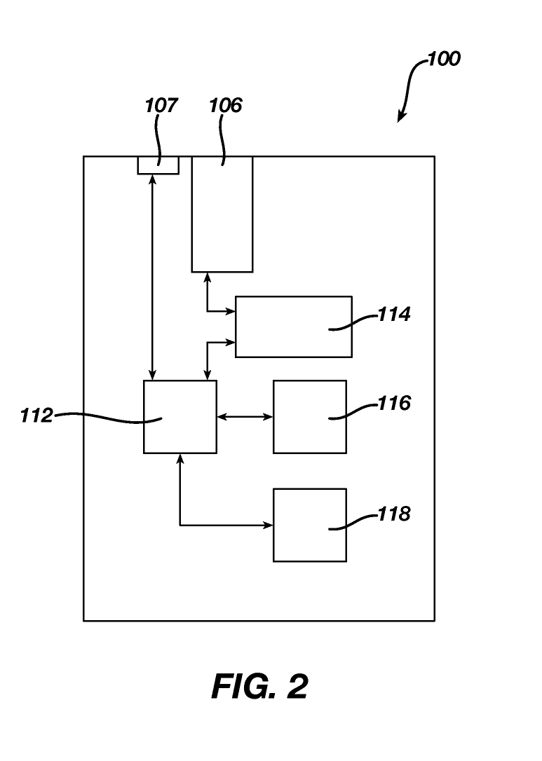

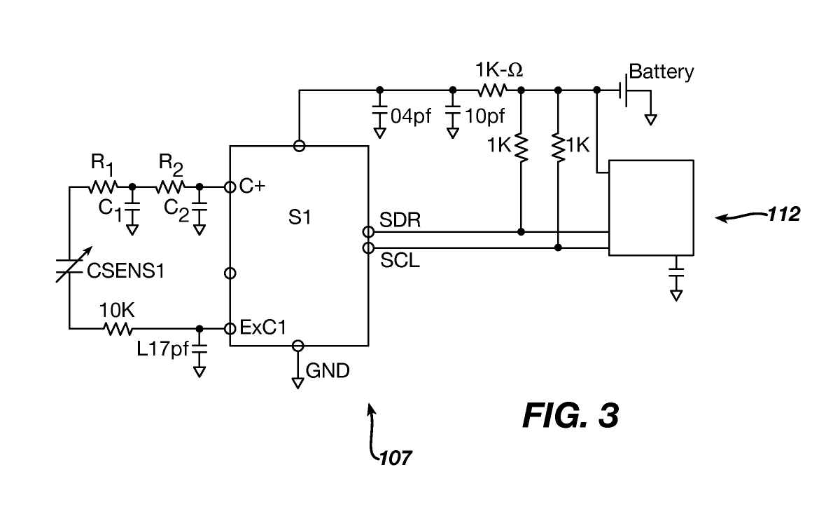

FIG. 1 is a simplified depiction of a hand-held test meter 100 according to an embodiment of the present invention. FIG. 2 is a simplified block diagram of various blocks of the hand-held test meter 100 of FIG. 1. FIG. 3 is a simplified combination schematic and block diagram of a body portion proximity sensor module, micro-controller and battery as can be employed in embodiments of hand-held test meters of the present invention.

Referring to FIGS. 1, 2 and 3, hand-held test meter 100 includes a display 102, a plurality of user interface buttons 104, a strip port connector 106, a body portion proximity sensor module 107, a USB interface 108, and a housing 110 (see FIG. 1). Referring to FIG. 2 in particular, hand-held test meter 100 also includes a micro-controller block 112, an analog electrical circuitry block 114, a digital electrical circuitry block 116, a memory block 118 and other electronic components (not shown) for applying an electrical bias (e.g., an alternating current (AC) and/or direct current (DC) bias) to an electrochemical-based analytical test strip (labeled TS in FIG. 1), and also for measuring an electrochemical response (e.g., plurality of test current values) and determining an analyte or characteristic based on the electrochemical response. To simplify the current descriptions, the figures do not depict all such electronic circuitry. Moreover, hand-held test meter 100 includes a battery (not depicted in the FIGs. but noted in FIG. 3) configured to power the hand-held test meter.

Display 102 can be, for example, a liquid crystal display or a bi-stable display configured to show a screen image. An example of a screen image during the determination of an analyte in a bodily fluid sample may include a glucose concentration, a date and time, an error message, and a user interface for instructing a user how to perform a test.

Strip port connector 106 is configured to operatively interface with an analytical test strip TS, such as an electrochemical-based analytical test strip configured for the determination of hematocrit and/or glucose in a whole blood sample. Therefore, the electrochemical-based analytical test strip is configured for operative insertion into strip port connector 106 and to operatively interface with micro-controller block 112 and analog electrical circuitry block 114 via, for example, suitable electrical contacts, wires, electrical interconnects or other structures known to one skilled in the art.

USB Interface 108 can be any suitable interface known to one skilled in the art. USB Interface 108 is an electrical component that is configured to power and provide a data line to hand-held test meter 100.

Micro-controller block 112 also includes a memory sub-block that stores suitable algorithms for the determination of an analyte based on the electrochemical response of an analytical test strip and to also determine a characteristic (e.g., hematocrit) of the introduced bodily fluid sample. Micro-controller block 112 can also include a suitable algorithm(s) for assessing a signal(s) from body portion proximity sensor 107 to ascertain if such signals are representative of a user's body portion being present within the predetermined distance. Once apprised of the present disclosure, such suitable algorithms will be apparent to one skilled in the art can include, for example, suitable algorithms that compare the signal magnitude versus a threshold(s) and/or that employ signal characteristics such as the rate-of-change of the signal. Micro-controller block 112 is disposed within housing 110 and can include any suitable micro-controller and/or micro-processer known to those of skill in the art. Suitable micro-controllers include, but are not limited to, micro-controllers available commercially from Texas Instruments (Dallas, Tex., USA) under the MSP430 series of part numbers; from ST MicroElectronics (Geneva, Switzerland) under the STM32F and STM32L series of part numbers; and Atmel Corporation (San Jose, Calif., USA) under the SAM4L series of part numbers).

In the embodiment of FIGS. 1-3, body portion proximity sensor module 107 is a capacitive touch sensor such as, for example, the commercially available capacitive touch sensor part number AD7153 (from Analog Devices, USA), which has an in-built digital to analog to convertor and, therefore, can transmit a data signal directly to the micro-controller using an I2C bus (SDA and SCL). When an analytical test strip is inserted into the strip port connector, the micro-controller wakes up, and wakes up the finger proximity sensor module but does not place the hand-held test meter into a full high-power active state. The label CESENS1 is used in FIG. 3 to depict the sensing capacitive element. Alternatively, the body portion sensor can be a capacitance-based body portion sensor that is configured for electrical communication with at least one electrode of an electrochemical-based analytical test strip such that the body portion proximity sensor module senses capacitance at an end of the electrochemical-based analytical test strip. In this circumstance, the electrode(s) becomes a portion of the electrical schematic component labeled CSENS1 in FIG. 3.

Upon a user's body portion (such as a user's finger) coming in close proximity to the strip port connector and thus in close proximity to the inserted analytical test strip, the finger proximity detection module senses the presence of the user's body portion and sends a command signal to the micro-controller. Upon receiving this command, the micro-controller turns on its ADC and starts sampling in the normal manner, and the body portion proximity detection module is put into a low power sleep mode.

Analog electrical circuitry block 114 can be any suitable analog electrical circuitry block known to those of skill in the art and is configured to provide excitation voltage and current waveforms to an inserted electrochemical-based analytical test strip and to provide signal conditioning and buffering during the receipt by an Analog-to-Digital (ADC) sub-block of the micro-controller of the resulting currents and voltages.

Digital electrical circuitry block 116 can be any suitable digital electrical circuitry block known to those of skill in the art and configured to provide a logical interface to the micro-controller and to provide for control and configuration via software commands.

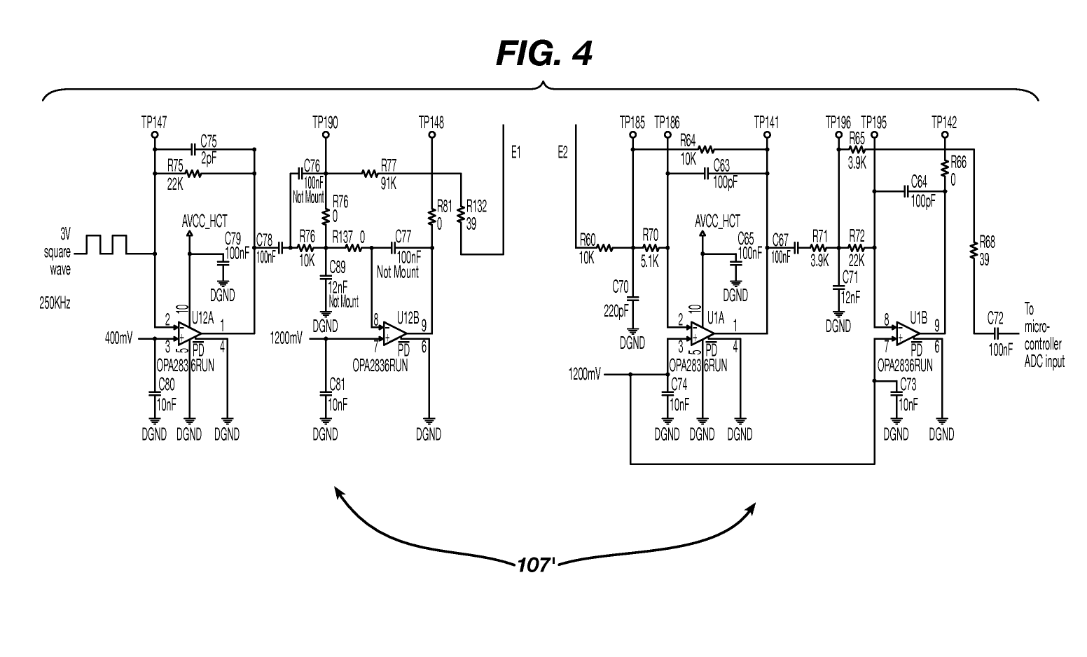

FIG. 4 is a simplified schematic of another body portion proximity sensor module 107′ as can be employed in alternative embodiments of hand-held test meters according to the present invention. Body portion proximity sensor 107′ is configured for operable to connection to electrodes (labeled E1 and E2 of FIG. 4 and including, for example, electrodes configured for the measurement of hematocrit in a whole blood sample) of an electrochemical-based analytical test strip that has been inserted into a strip port connector of the hand-held test meter.

Referring to FIG. 4, body portion proximity sensor module 107′ is configured to produce a 250 KHz sine wave signal from a 250 KHz square wave input signal. The 250 KHz sine wave signal is applied to electrodes of an inserted electrochemical-based analytical test strip (e.g., electrodes configured for the determination of hematocrit in a whole blood sample). At this frequency, the capacitive effect of the human body is detectable when a user's body portion (such as a user's finger) is touching or nearly touching (less than or equal to 10 mm away) the end of the electrochemical-based analytical test strip. When the user's finger is detected, the hand-held test meter can be switched to a high-power active state. The 250 KHz signal is then stopped. If required, the 250 KHz signal can be changed to a different frequency (e.g. 77 KHz) to measure impedance of a whole blood sample applied to the electrochemical-based analytical test strip for the purposes of determining an analyte and/or characteristic of such whole blood sample. By using a single electrical circuit for both beneficially sensing a user's body portion and making subsequent impedance measurements, the cost of a separate dedicated body portion proximity sensor module can be beneficially avoided. Such impedance measurements are described in, for example, U.S. patent application Ser. No. 13/857280 (filed on Apr. 5, 2013, Attorney Docket Number DDI5253USNP), which is hereby incorporated in full by reference. However, a dedicated body portion proximity sensor module has the benefit of being readily and independently powered in a low-power stand-by state.

The square wave of FIG. 4 can be generated, for example, using a micro-controller (e.g., such as micro-controller MSP430F5638 commercially available from Texas Instruments, Texas, USA). The filtering circuitry depicted in FIG. 4 produces a 250 KHz sine wave (at 147 mV) to the electrodes on the analytical strip.

As describe above, the schematic of FIG. 4 is configured to apply a sine wave signal of predetermined frequency to electrodes of the analytical test strip and measure the phase of the return signal. It has been shown that 250 KHz is particularly sensitive to a human finger capacitance effect and, therefore, the presence of a user's finger can be determined using the circuit of FIG. 4. Alternatively, other suitable frequencies in the range of 150 KHz to 500 KHz can be employed to sense the presence of a user's finger. The human body capacitance causes a phase change which is detected by the circuit of FIG. 4 in conjunction with a micro-controller of the hand-held meter.

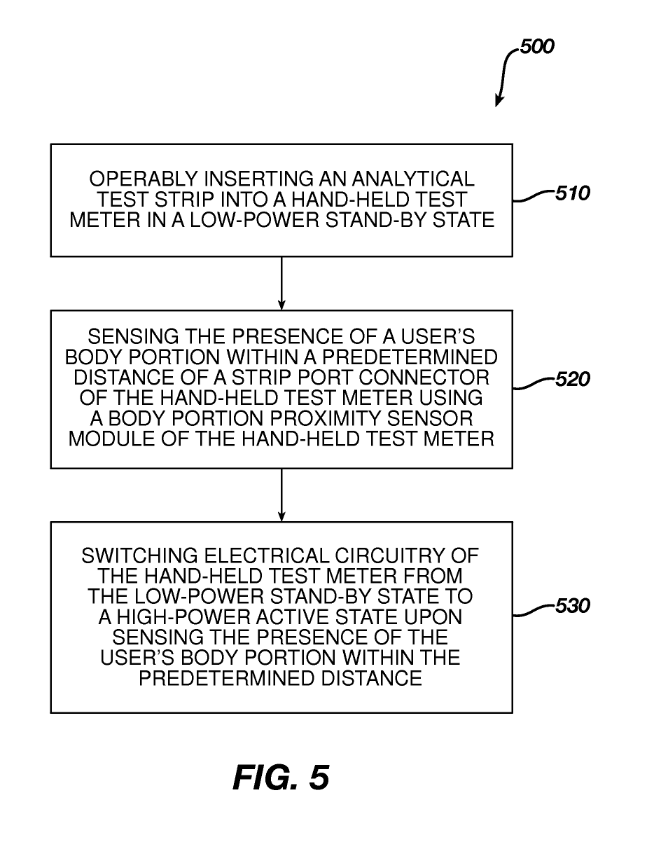

FIG. 5 is a flow diagram depicting stages in a method 500 for employing a hand-held test meter (e.g., hand-held test meter 100 of FIGS. 1, 2 and 3) for use with an analytical test strip for the determination of an analyte (such as glucose) in, or a characteristic (for example hematocrit) of, a bodily fluid sample (e.g., a whole blood sample expressed from a user's fingertip), according to an embodiment of the present invention.

Method 500 includes operably inserting an analytical test strip into a hand-held test meter in a low-power stand-by state (see step 510 of FIG. 5). Subsequently, at step 520 of method 500, a body portion proximity sensor module of a hand-held test meter is employed to sense the presence of a user's body portion within a predetermined distance of a strip port connector of the hand-held test meter (see step 520 of FIG. 5).

At step 530 of method 500, upon sensing of the user's body portion within the predetermined distance, electrical circuitry of the hand-held test meter is switched from the low-power stand-by state to a high-power active state upon sensing the presence of the user's body portion (for example, the user's finger, forearm or palm) within the predetermined distance.

Once apprised of the present disclosure, one skilled in the art will recognize that methods according to embodiments of the present invention, including method 500, can be readily modified to incorporate any of the techniques, benefits and characteristics of hand-held test meters according to embodiments of the present invention and described herein.

Once apprised of the present disclosure, one skilled in the art will recognize that the meters and methods according to embodiments of the present invention, including method 600, can employ any suitable electrochemical techniques, including those based on Cottrell current measurements, coulometry, amperometry, chronoamperometry, potentiometry, and chronopotentiometry.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. A hand-held test meter for use with an analytical test strip in the determination of an analyte in a bodily fluid sample, the hand-held test meter comprising:
a housing;
a micro-controller disposed in the housing;
a body portion proximity sensor module disposed at least partially in the housing; and
a strip port connector configured to operationally receive an analytical test strip;
wherein the body portion proximity sensor module is configured to sense presence of a user's body portion within a predetermined distance of the strip port connector and, upon sensing the presence of such a user's body portion, transmit a signal to the micro-controller indicating the presence of such a user's body portion.

2. The hand-held test meter of claim 1 wherein the predetermined distance is less than 10 mm.

3. The hand-held test meter of claim 1 wherein the predetermined distance is less than 5 mm.

4. The hand-held test meter of claim 1 wherein the body portion proximity sensor module is configured to sense presence of a user's finger based on a change in capacitance.

5. The hand-held test meter of claim 4 wherein the analytical test strip is an electrochemical-based analytical test strip with a plurality of electrodes, and
wherein the body portion proximity sensor module is configured for electrical communication with at least one electrode of the electrochemical-based analytical test strip such that the body portion proximity sensor module senses capacitance at an end of the electrochemical-based analytical test strip.

6. The hand-held test meter of claim 1 wherein the body portion proximity sensor module is configured to sense presence of a user's body portion based on phase change of a signal transmitted through an analytical test strip inserted into the strip port connector.

7. The hand-held test meter of claim 6 wherein the body portion proximity sensor module employs a sine wave applied to electrodes of an inserted analytical test strip to sense presence of a user's body portion within the predetermined distance of the strip port connector.

8. The hand-held test meter of claim 7 wherein the sine wave is derived from a square wave in a frequency range from 150 KHz to 500 KHz.

9. The hand-held test meter of claim 7 wherein the sine wave is derived from a 250 KHz square wave.

10. The hand-held test meter of claim 1 wherein the micro-controller is configured to switch the hand-held test meter from a low-power stand-by state to a high power activated state upon sensing of a user's body portion within the predetermined distance and following operable insertion of an analytical test strip into the strip port connector.

11. The hand-held test meter of claim 1 wherein the analytical test strip is an electrochemical-based analytical test strip.

12. The hand-held test meter of claim 11 wherein the electrochemical-based analytical test strip is an electrochemical-based analytical test strip configured for the determination of glucose in a whole blood bodily fluid sample.

13. The hand-held test meter of claim 1 wherein the user's body portion is the user's finger.

14. The hand-held test meter of claim 1 wherein the user's body portion is the user's forearm.

15. The hand-held test meter of claim 1 wherein the user's body portion is the user's palm.

16. A method for employing a hand-held test meter for use with an analytical test strip in the determination of an analyte in, or a characteristic of, a bodily fluid sample, the method comprising:
operably inserting an analytical test strip into a hand-held test meter in a low-power standby state;
employing a body portion proximity sensor module of a hand-held test meter to sense the presence of a user's body portion within a predetermined distance of a strip port connector of the hand-held test meter; and
switching electrical circuitry of the hand-held test meter from the low-power stand-by state to a high-power active state upon sensing the presence of the user's body portion within the predetermined distance.

17. The method of claim 16 further including:
determining at least one of an analyte in, and a characteristic of, a bodily fluid sample applied to the analytical test strip using a micro-controller of the hand-held test meter.

18. The method of claim 16 wherein the analytical test strip is an electrochemical-based analytical test strip configured for the determination of glucose in a whole blood sample.

19. The method of claim 16 wherein the predetermined distance is less than 10 mm.

20. The method of claim 16 wherein the predetermined distance is less than 5 mm.

21. The method of claim 16 wherein the body portion proximity sensor module is configured to sense presence of a user's body portion based on a change in capacitance.

22. The method of claim 21 wherein the body portion proximity sensor module is configured to sense presence of a user's finger based on phase change of a signal transmitted through an analytical test strip inserted into the strip port connector.

23. The method of claim 22 wherein the body portion proximity sensor employs a sine wave applied to electrodes of an inserted analytical test strip to sense presence of a user's finger within the predetermined distance of the strip port connector.

24. The method of claim 23 wherein the sine wave is derived from a square wave in a frequency range from 150 KHz to 500 KHz.

25. The method of claim 23 wherein the sine wave is derived from a 250 KHz square wave.

26. The method of claim 16 wherein the hand-held test meter includes a micro-controller configured to switch the hand-held test meter from a low-power stand-by state to a high power activated state upon sensing of a user's body portion within the predetermined distance and following operable insertion of an analytical test strip into the strip port connector.

27. The method of claim 16 wherein the user's body portion is the user's finger.

28. The method of claim 16 wherein the user's body portion is the user's forearm.

29. The method of claim 16 wherein the user's body portion is the user's palm.
